(19) United States
(12) Patent Application Publication
(10) Pub. No.: US 2026/0116324 A1
(43) Pub. Date: Apr. 30, 2026

(54) VEHICLE LOWER PORTION STRUCTURE

(71) Applicant: TOYOTA JIDOSHA KABUSHIKI KAISHA, Toyota-shi (JP)

(72) Inventor: Isao TAKAHASHI, Toyota-shi (JP)

(73) Assignee: TOYOTA JIDOSHA KABUSHIKI KAISHA, Toyota-shi (JP)

(21) Appl. No.: 19/291,969

(22) Filed: Aug. 6, 2025

(30) Foreign Application Priority Data
Oct. 30, 2024 (JP) 2024-190628

(51) Int. Cl. B60R 16/04; B62D 21/09; H01M 50/249

(52) U.S. Cl. CPC B60R 16/04; B62D 21/09; H01M 50/249; H01M 2220/20

(57) ABSTRACT

A vehicle lower portion structure includes a battery case that includes a lower casing including a first outer peripheral portion and an upper casing including a second outer peripheral portion facing the first outer peripheral portion and in which a battery cell is accommodated inside, a vehicle body frame member that supports a part of the outer peripheral portion, a first seal member that is in contact with a facing surface between the first outer peripheral portion and the second outer peripheral portion, and a second seal member that is in contact with the outer peripheral portion and the vehicle body frame member and is located below the first seal member on a lower side of a vehicle.

### CROSS-REFERENCE TO RELATED APPLICATION

This application claims priority to Japanese Patent Application No. 2024-190628 filed on October 30, 2024. The disclosure of the above-identified application, including the specification, drawings, and claims, is incorporated by reference herein in its entirety.

### BACKGROUND

### 1. Technical Field

The present disclosure relates to a vehicle lower portion structure.

### 2. Description of Related Art

Japanese Unexamined Patent Application Publication No. 2017-193290 (JP 2017-193290 A) discloses a vehicle in which an outer peripheral portion of a battery case accommodating a battery cell is supported by a vehicle body frame member, and a seal member is provided between the outer peripheral portion of the battery case and the vehicle body frame member.

### SUMMARY

In a case where a liquid such as water adhering to an upper surface of a battery case flows to an outer peripheral portion of the battery case, the outer peripheral portion may be corroded due to an influence of the liquid, and a hole may be formed in the outer peripheral portion. In JP 2017-193290 A, there is room for improvement in preventing the liquid from flowing toward the battery cell in the battery case through the hole formed in the outer peripheral portion in such a case.

In consideration of the circumstances described above, the present disclosure provides a vehicle lower portion structure capable of suppressing flow of a liquid toward a battery cell in a battery case in a case where the liquid adhering to an upper surface of the battery case flows to an outer peripheral portion of the battery case.

A vehicle lower portion structure according to a first aspect of the present disclosure includes:

a battery case that includes a lower casing including a first outer peripheral portion constituting an outer peripheral portion and an upper casing including a second outer peripheral portion constituting the outer peripheral portion and facing the first outer peripheral portion, the battery case being configured to accommodate a battery cell inside;

a vehicle body frame member configured to support a part of the outer peripheral portion;

a first seal member that is in contact with facing surfaces of the first outer peripheral portion and the second outer peripheral portion; and

a second seal member that is in contact with the outer peripheral portion and the vehicle body frame member, and is located below the first seal member on a lower side of a vehicle.

In the vehicle lower portion structure according to the first aspect, the first seal member is in contact with the facing surfaces of the first outer peripheral portion of the lower casing and the second outer peripheral portion of the upper casing. Furthermore, the second seal member is in contact with the outer peripheral portion constituted by the second outer peripheral portion of the upper casing and the first outer peripheral portion of the lower casing, and with the vehicle body frame member, and the second seal member is located below the first seal member on the lower side of the vehicle. Therefore, for example, in a case where the liquid adhering to an upper surface of the battery case flows to the outer peripheral portion of the battery case, it is possible to store the liquid in a portion below the first seal member of the battery case due to the action of the second seal member. Therefore, the vehicle lower portion structure according to the first aspect can suppress the flow of the liquid toward the battery cell in the battery case in a case where the liquid adhering to the upper surface of the battery case flows to the outer peripheral portion of the battery case.

According to a second aspect of the vehicle lower portion structure, in the first aspect, the first outer peripheral portion and the second outer peripheral portion each include an upper step portion and a lower step portion that is located on an outer peripheral side and a lower side with respect to the upper step portion, the first seal member is in contact with the facing surfaces of the upper step portions of the first outer peripheral portion and the second outer peripheral portion, and the second seal member is in contact with the lower step portion of the outer peripheral portion and the vehicle body frame member.

With the vehicle lower portion structure according to the second aspect, the second seal member can be located below the first seal member on the lower side of the vehicle without complicating the structure of the battery case.

According to a third aspect of the vehicle lower portion structure, in the first aspect or the second aspect, a part of the outer peripheral portion is a to-be-joined portion that is joined to the vehicle body frame member, and the second seal member is in contact with the to-be-joined portion and the vehicle body frame member.

In the vehicle lower portion structure according to a third aspect, it is possible to suppress corrosion caused by the liquid adhering to the battery case, both at the to-be-joined portion that is a part of the outer peripheral portion of the battery case and is a portion that is joined to the vehicle body frame member, and at a joined portion on the vehicle body frame member corresponding to the to-be-joined portion.

According to a fourth aspect of the vehicle lower portion structure, in the first aspect or the second aspect, an upper surface of the upper casing constitutes a floor panel of the vehicle that includes the vehicle body frame member.

In the vehicle lower portion structure according to the fourth aspect, the upper surface of the upper casing also serves as a floor panel of the vehicle. Therefore, for example, in a case where a liquid in a container in the vehicle is spilled out of the container, the liquid may adhere to the floor panel (the upper surface of the upper casing). The vehicle lower portion structure according to the fourth aspect can suppress the flow of the liquid toward the battery cell in the battery case in such a case.

As described above, the vehicle lower portion structure according to the present disclosure has an excellent effect of being capable of suppressing flow of a liquid toward a battery cell in a battery case in a case where the liquid adhering to an upper surface of the battery case flows to an outer peripheral portion of the battery case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a vehicle body frame member and a battery module of a vehicle to which a vehicle lower portion structure according to an embodiment is applied;

FIG. 2 is a schematic cross-sectional view taken along line II-II of FIG. 1;

FIG. 3 is an enlarged view of a front part of the cross-sectional view of FIG. 2;

FIG. 4 is an enlarged view similar to FIG. 3 when a through-hole caused by corrosion is provided in an outer peripheral portion of a battery case; and

FIG. 5 is a schematic cross-sectional view taken along line V-V of FIG. 1.

### DETAILED DESCRIPTION OF EMBODIMENTS

Hereinafter, a vehicle lower portion structure according to an embodiment will be described with reference to the accompanying drawings. In addition, an arrow UP, an arrow FR, and an arrow LH in each of the drawings indicate an upper side in the vehicle vertical direction, a front side in the vehicle front-rear direction, and a left side in the vehicle left-right direction, respectively.

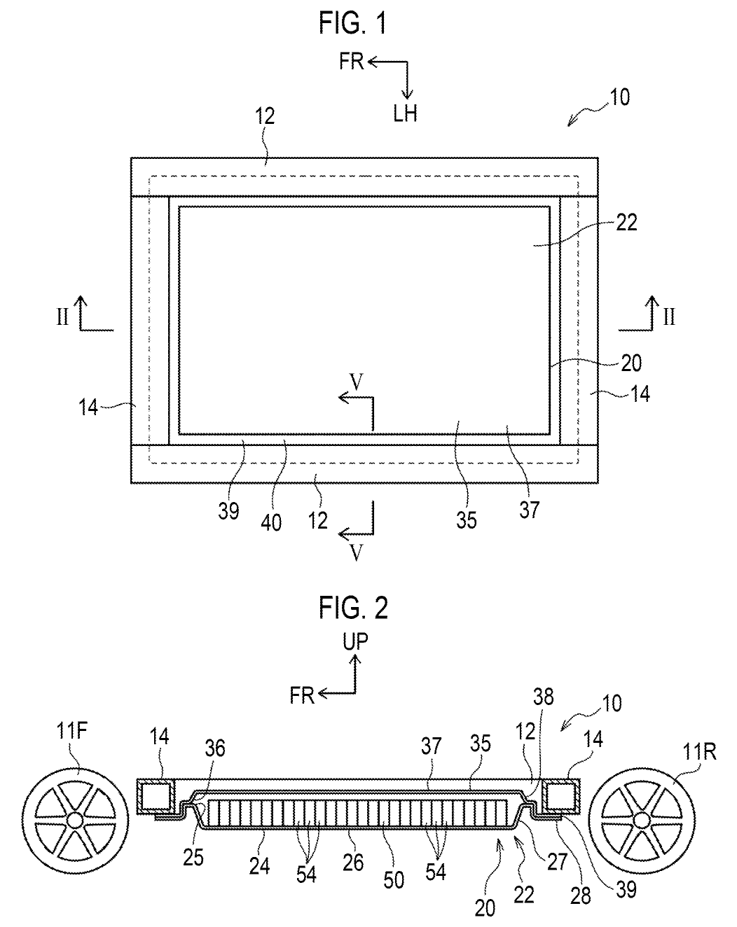

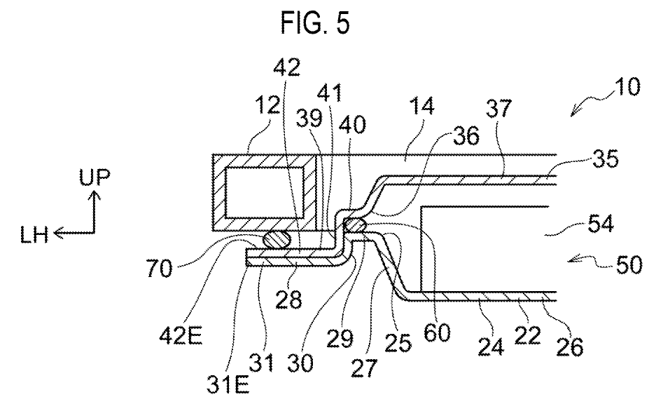

As shown in FIGS. 1 and 2, a vehicle 10 to which a vehicle lower portion structure of the present embodiment is applied includes a pair of left and right front wheels 11F, a pair of left and right rear wheels 11R, a pair of left and right rockers 12 that is a part of a vehicle body frame member extending in the vehicle front-rear direction, and a pair of front and rear cross members 14 that is a part of the vehicle body frame member extending in the vehicle width direction (left-right direction) and having both ends fixed to the left and right rockers 12. The rockers 12 and the cross members 14 are made of metal. As shown in FIGS. 2 and 5, the cross-sectional shapes of the rockers 12 and the cross members 14 are rectangular.

A battery module 20 according to the present embodiment includes a battery case 22, a battery stack 50, and a first seal member 60.

The battery case 22 includes a lower casing 24 and an upper casing 35. The lower casing 24 and the upper casing 35 are integrally molded metal products.

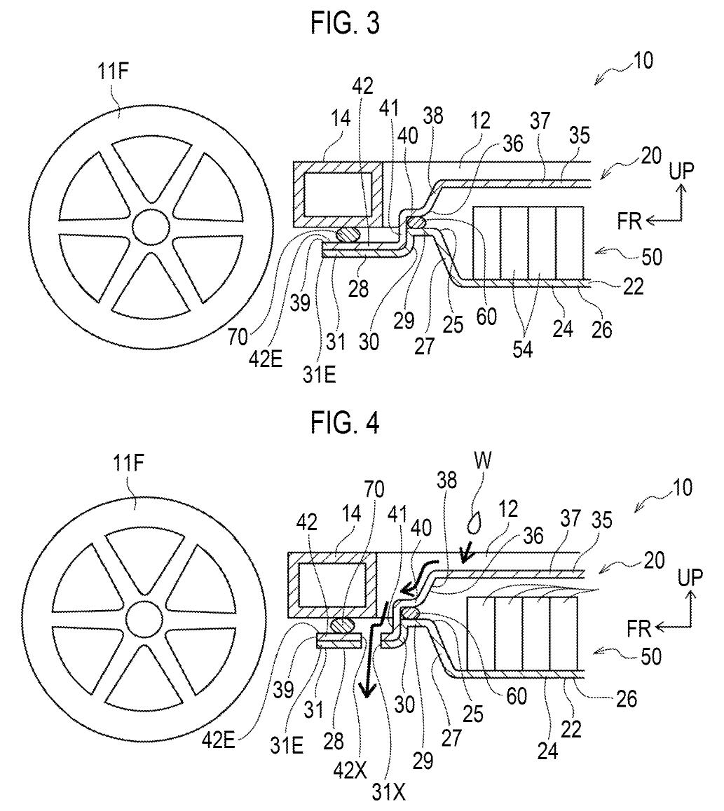

The lower casing 24 is a hollow body in which an opening portion 25 is provided on an upper surface. The lower casing 24 has a bottom plate portion 26, a peripheral wall portion 27, and a first outer peripheral portion (outer peripheral portion) 28. A planar shape of the peripheral wall portion 27 is an annular shape, and a lower end portion of the peripheral wall portion 27 is connected to an outer peripheral edge portion of the bottom plate portion 26. A planar shape of the first outer peripheral portion 28 is an annular shape, and an inner peripheral edge portion of the first outer peripheral portion 28 is connected to an upper end portion of the peripheral wall portion 27. As shown in FIGS. 3 and 5, the first outer peripheral portion 28 includes an upper step portion 29 that is connected to the upper end portion of the peripheral wall portion 27, a downwardly extending portion 30 that extends downward from an outer peripheral edge portion of the upper step portion 29, and a lower step portion 31 that extends substantially horizontally toward an outer peripheral side from a lower end portion of the downwardly extending portion 30.

The upper casing 35 is a hollow body in which an opening portion 36 is formed on a lower surface. The upper casing 35 includes a top plate portion 37, a peripheral wall portion 38, and a second outer peripheral portion (outer peripheral portion) 39. A planar shape of the peripheral wall portion 38 is an annular shape, and an upper end portion of the peripheral wall portion 38 is connected to an outer peripheral edge portion of the top plate portion 37. A planar shape of the second outer peripheral portion 39 is an annular shape, and an inner peripheral edge portion of the second outer peripheral portion 39 is connected to a lower end portion of the peripheral wall portion 38. As shown in FIGS. 3 and 5, the second outer peripheral portion 39 includes an upper step portion 40 that is connected to the lower end portion of the peripheral wall portion 38, a downwardly extending portion 41 that extends downward from an outer peripheral edge portion of the upper step portion 40, and a lower step portion 42 that extends substantially horizontally toward an outer peripheral side from a lower end portion of the downwardly extending portion 41. A vertical dimension of the downwardly extending portion 41 is greater than a vertical dimension of the downwardly extending portion 30.

As shown in FIGS. 2 and 3, the battery stack 50 is provided inside the lower casing 24. The battery stack 50 includes a large number of battery cells 52 arranged in the front-rear direction, a large number of bus bars (not shown), and a cooler (not shown).

As shown in FIGS. 2 and 3, the battery stack 50 is disposed in an inner space of the lower casing 24 in a state of being separated from the upper casing 35, and is disposed on and fixed to the bottom plate portion 26. In this state, the first seal member 60 that has an annular shape and is made of a flexible material is placed on the entire upper surface of the upper step portion 29 of the first outer peripheral portion 28 of the lower casing 24 (not shown in FIG. 2). Furthermore, in this state, the upper casing 35 covers the lower casing 24 from above. That is, the entire lower step portion 42 of the second outer peripheral portion 39 is placed on the upper surface of the lower step portion 31 of the first outer peripheral portion 28, and a lower step portion of an inner peripheral surface of the downwardly extending portion 41 faces an outer peripheral surface of the downwardly extending portion 30. Accordingly, the first seal member 60 is deformed between the upper surface of the upper step portion 29 of the first outer peripheral portion 28 and the lower surface of the upper step portion 40 of the second outer peripheral portion 39. In other words, the first seal member 60 is in liquid-tight contact with the entire periphery of the upper surface of the upper step portion 29 and the entire periphery of the lower surface of the upper step portion 40. Furthermore, a plurality of locations of to-be-supported portions 31E, 42E that are outer peripheral portions of the lower step portion 31 of the first outer peripheral portion 28 and the lower step portion 42 of the second outer peripheral portion 39, are fixed to each other by a plurality of fixing members. This fixing member is, for example, a bolt that penetrates the to-be-supported portions 31E, 42E and a nut that is capable of being screwed to the bolt. Accordingly, the battery module 20 in which the entire to-be-supported portion 31E and the entire to-be-supported portion 42E are in contact with each other is completed. Even in a case where a liquid such as water enters a gap between the to-be-supported portion 31E of the lower step portion 31 of the lower casing 24 and the to-be-supported portion 42E of the lower step portion 42 of the upper casing 35 in the battery module 20 having such a configuration, the liquid is blocked from flowing toward the battery stack 50 by the first seal member 60.

The battery case 22 of the battery module 20 having such a configuration is supported by the rockers 12 and the cross members 14. That is, as shown in FIGS. 1 to 3 and 5, in a state where the top plate portion 37 and the peripheral wall portion 38 of the upper casing 35 are located in a space surrounded by the rockers 12 and the cross members 14, the lower step portion 42 of the second outer peripheral portion 39 is brought close to a lower surface of each rocker 12 and each cross member 14 from below.

Furthermore, as shown in FIGS. 3 and 5, the second seal member 70 that has an annular shape and is made of a flexible material is placed on the entire upper surface of the lower step portion 42 of the second outer peripheral portion 39 of the upper casing 35 (not shown in FIG. 2). The second seal member 70 is located on an inner peripheral side with respect to the to-be-supported portions 31E, 42E. Furthermore, in this state, the lower surfaces of the rockers 12 and the cross members 14 and the plurality of locations of the to-be-supported portions 31E, 42E of the lower step portions 31, 42 are fixed to each other by the plurality of fixing members. This fixing member is, for example, a bolt that penetrates a bottom plate of the rocker 12, a bottom plate of the cross member 14, and the to-be-supported portions 31E, 42E, and a weld nut that is fixed to an upper surface of the bottom plates of the rocker 12 and the cross member 14, the weld nut being screwable onto the bolt. Since the first outer peripheral portion 28 and the second outer peripheral portion 39 are pulled upward by these fixing members, the to-be-supported portion (to-be-joined portion) 42E of the second outer peripheral portion 39 is joined to the lower surface of each rocker 12 and each cross member 14. Furthermore, since the first outer peripheral portion 28 and the second outer peripheral portion 39 are pulled upward, as shown in FIGS. 3 and 5, the second seal member 70 is deformed between the upper surface of the lower step portion 42 and the lower surface of the bottom plate of the rocker 12 and the cross member 14. In other words, the second seal member 70 is in liquid-tight contact with the entire periphery of the upper surface of the lower step portion 42 and the entire periphery of the lower surface of the bottom plates of the rockers 12 and the cross members 14. Even in a case where a liquid such as water enters a gap between the bottom plates of the rockers 12 and the cross members 14 and the to-be-supported portion 42E of the lower step portion 42 of the upper casing 35, the liquid is blocked from flowing toward a downwardly extending portion 41 side by the second seal member 70.

Furthermore, the upper surface of the top plate portion 37 of the upper casing 35 constitutes a floor panel of the vehicle 10. The upper surface of the top plate portion 37 is covered with a cloth-like mat material (not shown).

### Operation and Effect

Next, the operation and effect of the present embodiment will be described.

In the vehicle 10 according to the present embodiment, the first seal member 60 is in liquid-tight contact with facing surfaces of the upper step portion 29 of the first outer peripheral portion 28 of the lower casing 24 and the upper step portion 40 of the second outer peripheral portion 39 of the upper casing 35. Furthermore, the second seal member 70 is in liquid-tight contact with the lower step portion 42 of the second outer peripheral portion 39 of the upper casing 35 and the lower surfaces of the bottom plates of the rockers 12 and the cross members 14. Furthermore, the lower step portion 42 of the second outer peripheral portion 39 is located below the upper step portion 29 of the lower casing 24. Therefore, the second seal member 70 is located below the first seal member 60 on a lower side of the vehicle. Therefore, for example, in a case where an occupant of the vehicle 10 spills a liquid contained in a container inside the vehicle on the mat material, the liquid W passes downward through the mat material and then adheres to an upper surface of the top plate portion 37 (see FIG. 4). Furthermore, the liquid W may flow along a front part of the peripheral wall portion 38 to an upper surface of the lower step portion 42.

In this case, the movement of the liquid W to the to-be-supported portion 42E side is blocked by the second seal member 70. Therefore, the liquid W is stored in a space surrounded by a front part of the second seal member 70, a front part of the lower step portion 42, and a front part of the downwardly extending portion 41. That is, the possibility that the liquid W enters the inside of the battery case 22 and adheres to the battery cell 54 is low.

Meanwhile, in a case where the liquid W is accumulated in the space for a long period of time, a part of the lower step portion 42 may be corroded as shown in FIG. 4, and a through-hole 42X may be provided in the part of the lower step portion 42. In this case, the liquid W may enter a gap between the lower step portion 42 and the lower step portion 31 through the through-hole 42X, and the liquid W may flow toward an inner peripheral side through the gap. However, the downwardly extending portion 30 of the lower casing 24 is located on the inner peripheral side of the gap. Therefore, the movement of the liquid W to the inner peripheral side is blocked by the downwardly extending portion 30. That is, the possibility that the liquid W that has entered the gap moves upward through a gap between the downwardly extending portion 30 and the downwardly extending portion 41 is low.

Furthermore, the first seal member 60 is in liquid-tight contact with the entire periphery of the upper surface of the upper step portion 29 and the entire periphery of the lower surface of the upper step portion 40. Therefore, even in a case where the liquid W moves upward through the gap between the downwardly extending portion 30 and the downwardly extending portion 41, the possibility that the liquid W passes through a gap between the upper step portion 29 and the upper step portion 40 and enters the inside of the battery case 22 to adhere to the battery cell 54 is low.

Furthermore, the battery case 22 includes the upper step portions 29, 40 and the lower step portions 31, 42 located below the upper step portions 29, 40. Therefore, it is possible to locate the first seal member 60 above the second seal member 70 on an upper side of a vehicle without complicating the structure of the battery case 22.

Furthermore, the second seal member 70 blocks the liquid W from flowing to the to-be-supported portion 42E that is a part of the second outer peripheral portion 39 of the battery case 22 and is a portion joined to the rockers 12 and the cross members 14. Therefore, it is possible to suppress corrosion caused by the liquid W adhering to the battery case 22, both at the to-be-supported portion 42E, and at a joined portion on the rockers 12 and the cross members 14 corresponding to the to-be-supported portion 42E.

After the through-hole 42X is provided in a part of the lower step portion 42, the liquid W is accumulated in a space surrounded by a front part of the second seal member 70, a front part of the lower step portion 42, and a front part of the downwardly extending portion 41 for a long period of time. In this case, as shown in FIG. 4, a part of the lower step portion 31 may be corroded, and a through-hole 31X communicating with the through-hole 42X may be provided in the part of the lower step portion 31. In this case, since the liquid W flows downward below the first outer peripheral portion 28 through the through-holes 42X, 31X, the possibility that the liquid W adheres to the battery cell 54 is very low even in this case.

Although the vehicle lower portion structure according to the embodiment has been described above, the design of the vehicle lower portion structure can be changed as appropriate without departing from the scope of the present disclosure.

For example, the upper step portion 29, the downwardly extending portion 30, and the lower step portion 31 may be provided only at a front part and a rear part of the first outer peripheral portion 28, and the upper step portion 40, the downwardly extending portion 41, and the lower step portion 42 may be provided only at a front part and a rear part of the second outer peripheral portion 39. In addition, the upper step portion 29, the downwardly extending portion 30, and the lower step portion 31 may be provided only at both left and right side portions of the first outer peripheral portion 28, and the upper step portion 40, the downwardly extending portion 41, and the lower step portion 42 may be provided only at both left and right side portions of the second outer peripheral portion 39.

What is claimed is:

1. A vehicle lower portion structure comprising:
a battery case that includes a lower casing including a first outer peripheral portion constituting an outer peripheral portion and an upper casing including a second outer peripheral portion constituting the outer peripheral portion and facing the first outer peripheral portion, the battery case being configured to accommodate a battery cell inside;
a vehicle body frame member configured to support a part of the outer peripheral portion;
a first seal member that is in contact with facing surfaces of the first outer peripheral portion and the second outer peripheral portion; and
a second seal member that is in contact with the outer peripheral portion and the vehicle body frame member, and is located below the first seal member on a lower side of a vehicle.

2. The vehicle lower portion structure according to claim 1, wherein:
the first outer peripheral portion and the second outer peripheral portion each include an upper step portion and a lower step portion that is located on an outer peripheral side and a lower side with respect to the upper step portion;
the first seal member is in contact with the facing surfaces of the upper step portions of the first outer peripheral portion and the second outer peripheral portion; and
the second seal member is in contact with the lower step portion of the outer peripheral portion and the vehicle body frame member.

3. The vehicle lower portion structure according to claim 1, wherein:
a part of the outer peripheral portion is a to-be-joined portion that is joined to the vehicle body frame member; and
the second seal member is in contact with the to-be-joined portion and the vehicle body frame member.

4. The vehicle lower portion structure according to claim 1, wherein an upper surface of the upper casing constitutes a floor panel of the vehicle that includes the vehicle body frame member.
